(19) United States
(12) Patent Application Publication
(10) Pub. No.: US 2015/0228037 A1
(43) Pub. Date: Aug. 13, 2015

(54) DYNAMIC GATING FOR AUTOMATED SELECTION OF COMPARABLES

(71) Applicant: Fannie Mae, Washington, DC (US)

(72) Inventors: Weifeng Wu, Arlington, VA (US); Zachary Dawson, Washington, DC (US); Fotis Gavriil, Vienna, VA (US); Eric Rosenblatt, Derwood, MD (US); John Treadwell, Washington, DC (US)

(73) Assignee: FANNIE MAE, Washington, DC (US)

(21) Appl. No.: 14/179,012

(22) Filed: Feb. 12, 2014

(51) Int. Cl. G06Q 50/16

(52) U.S. Cl. CPC G06Q 50/16

(57) ABSTRACT

A comparable property selection system and method employs dynamic gating in the selection of comparable properties. When the most restrictive comparable selection algorithm fails to identify enough comparable sales to use as inputs to the downstream analytics processes, the system does not simply expand the pool or solely expand the corresponding geographical area. Instead, the system automatically loosens and tightens property search filters iteratively to expand and shrink the size of a local geographic and economic market to locate comparables that have property characteristics that most closely reflect the real estate market considerations a buyer, or an appraiser acting as a buyer, would evaluate in a heterogeneous market.

### BACKGROUND OF THE INVENTION

1. Field of the Invention

This application relates to generally to automated selection of comparable properties and more particularly to dynamic gating in the automated selection of comparables.

2. Description of the Related Art

It is generally known to use computer modeling for real estate comparables selection. However, sometimes a subject property, due to location and property characteristics, still presents significant difficulties to comparables selection that current comparable sales models do not overcome.

When searching for comparables for a subject property, an automated valuation model typically searches for comparable properties located within the vicinity of the subject and sold relatively recently. The comparables it selects are of similar size and age and sit on a parcel of land similar to that of the subject property.

A model may look for similar measurable property characteristics such as age, gross living area, and bedroom count, among others.

A close economic proximity to the subject property may also be examined; that is, the estimated market value of characteristic differences is less than a specified dollar or percentage threshold.

Geographic proximity to the subject property may also be examined. The comparables selected are as close as possible to the subject neighborhood or tract in which the subject property is located.

Typically, a model applies such criteria and then concludes its analysis and offers results correspondingly.

However, while this selection process successfully locates comparable properties when the local market is homogenous and real estate transactions are plentiful, it often fails when a subject property has unusual property characteristics or the geographic area in which the subject property is located lacks a sufficient quantity of real estate transactions.

### SUMMARY OF THE INVENTION

A comparable property selection system and method employs dynamic gating in the selection of comparable properties. When the most restrictive comparable selection algorithm fails to identify enough comparable sales to use as inputs to the downstream analytics processes, the system does not simply expand the pool or solely expand the corresponding geographical area. Instead, the system automatically loosens and tightens property search filters iteratively to expand and shrink the size of a local geographic and economic market to locate comparables that have property characteristics that most closely reflect the real estate market considerations a buyer, or an appraiser acting as a buyer, would evaluate in a heterogeneous market.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a flow diagram illustrating an example of dynamic gating to identify comparable properties.

FIG. 2 is a tabular diagram illustrating examples of filtering information.

FIG. 3 is a tabular diagram illustrating an example of subject property information.

FIG. 4 is a tabular diagram illustrating an example of search constraints corresponding to filtering based upon the subject property information.

FIGS. 5A-B are a flow diagram illustrating the dynamic gating to identify comparable properties in more detail.

FIGS. 6A-B are block diagrams illustrating examples of systems in which comparable property modeling with dynamic gating operates.

FIG. 7 is a block diagram illustrating an example of a comparable property selection with dynamic gating application.

FIGS. 8A-C are display diagrams illustrating examples of map images and corresponding property grid data.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

Dynamic gating for automated selection of comparables provides for an identification of comparables that does not merely run an Automated Valuation Model (AVM) to generate a listing and corresponding rank ordering of comparable properties. Instead, the selection of comparables is dynamic. The identification and selection of comparables does not merely apply a set of search criteria, but instead iteratively expands and contracts selection filters until the iterations produce a list of property comparables that come closest to the ideal.

Consequently, dynamic gating for automated selection of comparables combines appraiser subject matter expertise (in terms of the methodology behind the comp selection) with the analytical component of adjusting for subject/comp characteristic differences. This is a significant improvement over relying solely on the rank ordering of analytic model results to select comparable sales.

The dynamic gating technique may be used to generate output indicative of the best comparables for a given subject property. It may also be used as an evaluation tool, wherein the comparable properties generated through dynamic gating are compared to an existing human appraisal report that is under review.

The presumption that properties more similar to a subject in terms of physical characteristics, location, and time of sale make the best comparables seems reasonable. However, in a local real estate market, at any given point of time, the properties for sale may not closely match the ideal property a buyer/appraiser has in mind. Knowing this, characteristic and geographic filters are loosely constrained to facilitate the return of the highest number of possible comparables. After a large set of possible comparable properties is compiled, current methodology relies on ranking to isolate comparables acceptable for use during an appraisal review.

Dynamic gating begins instead with an ideal set of tightly constrained filters to model an ideal comparable for a subject property, and then searches a local market for an initial set of ideal potential comparables. This is in contrast to a conventional AVM approach wherein a ranking is simply generated based upon the subject property and the corresponding geographic designations input to the AVM.

Because ideal comparables are difficult to locate, there will likely be insufficient search results. When this occurs, the dynamic gating system selectively widens the filter gates using less constrained search options until potential comparables are found. The process of loosening the filter options continues iteratively until search results return the necessary quantity of potential comparables. Choices are readily configurable to be scalable, depending on intended use.

Searching for comps may, for example, begin at the tract plus neighboring tracts level. It should be noted that the predetermined threshold for the desired number of comparables may be different depending upon the extent of dynamic gating. For example, on an initial pass with the smallest geographic area and all the characteristic filters at their most restrained (least relaxed), the target number of comps may, for example, be 20 comparables. However, the target number of comps could be reduced in subsequent iterations to 10. The update to the predetermined threshold may vary depending upon conditions. In any event, the iterations continue until the targeted number of comparables is returned.

The dynamic gating is configured to adapt to situations where the subject is unique among a pool of comparable sales. By gradually loosening specified gates, the dynamic gating avoids considering absurdly different or distant comps that the current automated valuation model would include.

The order in which gates are relaxed is also configurable, so that the corresponding system can be made to mirror the order of preference that a buyer/appraiser would place on a home's characteristics in various circumstances.

Dynamic gating seeks to balance the number of comps it adds to the pool to the similarity of the comps to the subject. Ideally, if all the comps initially selected have similar characteristics to the target property, then increasing the number of comps helps produce a more accurate prediction of sales price. On the other hand, if expanding the geographic area of the comp search adds many dissimilar comps to the calculation, then a tradeoff is needed wherein greater numbers of comps are sacrificed in favor of having a smaller set of high quality comps.

In one example, dynamic gating operates such that when searching a smaller geographic area, preference is given to the number/quantity of comps. But when the geographic search is expanded, then preference is given to a smaller number of very similar comps over a large comp pool, whose members are not all that similar to the subject. The underlying principle is to expand and shrink the geographic and characteristic search area, and at the same time, vary the target number of comps at each stage, depending on the degree of homogeneity of the comp candidate pool.

The dynamic gating settings are also versatile and customizable. Although particular examples are described herein, other examples with different filtering criteria and corresponding sequences for the iterative process are readily ascertainable and contemplated as falling within the scope of this description. Different implementations of comparable selection that implement dynamic gating could relax or tighten thresholds in different ways.

Conceptually the algorithm used in dynamic gating is iterative; however, it is implemented in a computationally efficient manner. For instance, it determines which gates each comparable sale can pass through in a single loop. In addition, the algorithm stops as soon as an ideal set of comparables is determined.

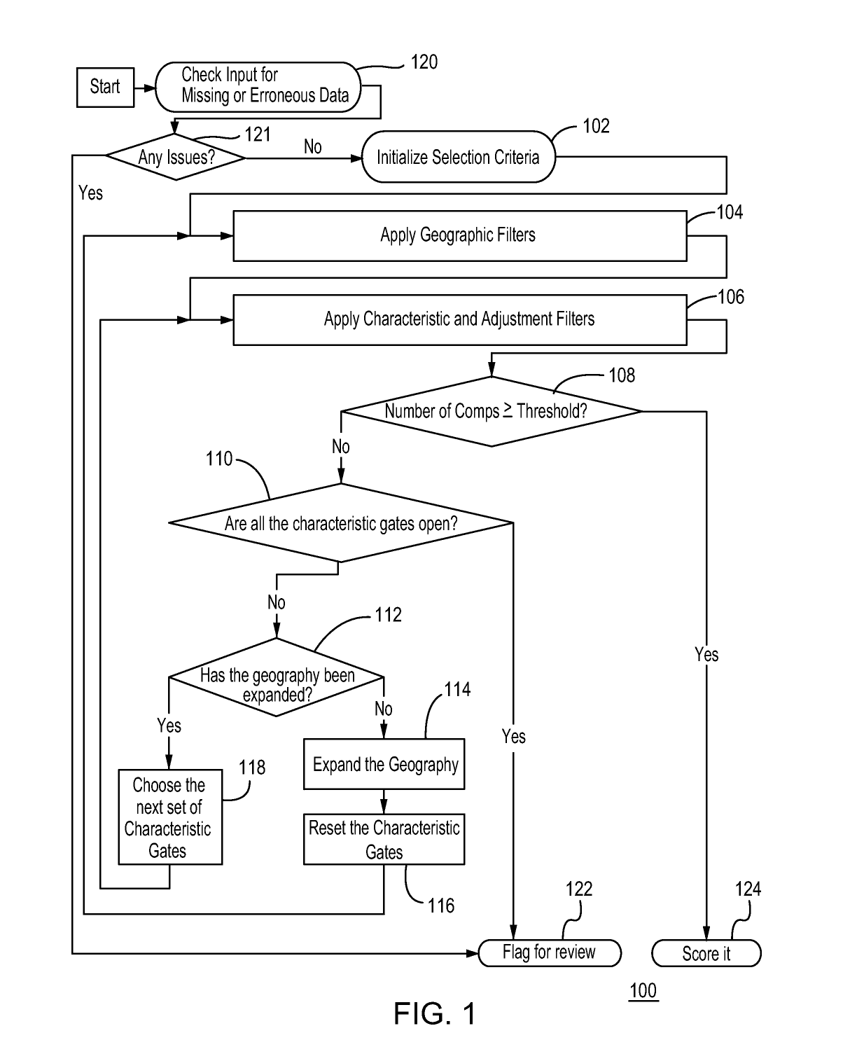

FIG. 1 is a flow diagram illustrating an example of a dynamic gating process 100 to identify comparable properties. Initially, the input is checked 120 for missing or erroneous data, and if any issues are detected 121, then the situation may be flagged 122 for review.

The selection criteria are then initialized 102. As noted, the criteria are user-configurable, so a user may input settings as to the geographic filtering, characteristic filtering, and/or adjustment filtering. For example, the geographical filtering would start at the smallest geographic delineation that would be contemplated for a given scenario, and may have one or more iterative expansions according to user input.

Similarly, the property characteristic filters could be arranged as desired, with some embodiments relaxing the criteria for one characteristic at a time, and others potentially relaxing multiple characteristics on each pass. Additionally, the definition of which characteristics are to be relaxed on each iteration may be customized by the user (i.e., the sequence of characteristics to be relaxed), depending upon which characteristics are believed to be most important. Still further, in some examples filtering may be re-tightened for some characteristics as other characteristics are loosened.

The filtering for adjustments may also be configured by the user. For example, in one embodiment, the filtering may exclude any properties whose net adjustments in relation to the subject property exceed a fixed percentage of the overall value. Alternatively, customization may exclude significant individual adjustment amounts for individual characteristics, again according to user preference.

Once the selection criteria are initialized 102, the dynamic gating process 100 continues with initial application 104 of the current geographic filter and then application 106 of the property characteristic and adjustment filters.

Each of these will typically act to limit the number of potential comparable properties for a given subject property. Generally, the process will continue until it is determined 108 that the number of comparable properties exceeds a predetermined threshold. As noted above, a first predetermined threshold for an initial pass may exceed the acceptable (second) predetermined threshold used for subsequent passes of the iterative dynamic gating process 100. For example, the first predetermined threshold may be 20, and the second predetermined threshold may be a lower number, such as 7 or 10. The setting of the second predetermined threshold may also be made based upon the results of the initial pass, since each pass relaxes certain filters to produce additional results. For example, a setting that is a percentage (e.g., 25%) above the initial pass may be used. Thus, if the initial pass produces 8 comparables, the second predetermined threshold might be set to 10 comparables. Alternatively, a set number of additional comparables above the number found on the first pass may be used.

The dynamic gating process basically continues until the geographic filtering has been fully expanded (largest acceptable area) and all of the property characteristic gates (filters) have been opened (i.e., least restrictive filtering), or until it is determined 108 that the number of resultant comparable properties on any given iteration exceeds the predetermined threshold.

If it is determined 108 that the updated number of comparable properties meets or exceeds the predetermined threshold, the results may be presented for examination by the user, or subject to other processing such as scoring 124 of the results. Note that scoring refers to assessing the quality of the comp selection returned by the model. For example, whether the comps returned by the model are much more similar to the subject than the ones a human appraiser chose. The scoring 124 refers to how well the appraiser comps compare to the model's comps. If the number of comps returned exceeds the predetermined threshold, then the only time the algorithm would not be able to score an appraisal is when the input has missing or erroneous data (120), which is examined and determined before the filtering process.

If the threshold number of comparable properties is not met, then filters are relaxed until a suitable result is achieved (threshold met, score 124 or flag results for review 122) or until all filters are relaxed and there are still insufficient comparables (flag for review 122).

This embodiment is arranged such that the geographic filter is initially relaxed, and then the property characteristic filters are iteratively relaxed. Thus, when it is initially determined 110 that all of the property characteristic filters have not been relaxed (opened), and it is determined 112 that the geographic filtering is not expanded, the geographic filter is expanded 114 and the property characteristic gates are reset 116 to the initial setting. After that, on a return pass (i.e., the next iteration, if not enough comparables are still not found) it will be determined 112 that the geographic filtering is expanded, and the relaxation commences to the iterative relaxing of the property characteristic filtering, denoted as choosing 118 the next set of characteristic gates in FIG. 1.

The process continues until, as explained, the number of comparable properties meets or exceeds the predetermined threshold, whereupon it is flagged or scored.

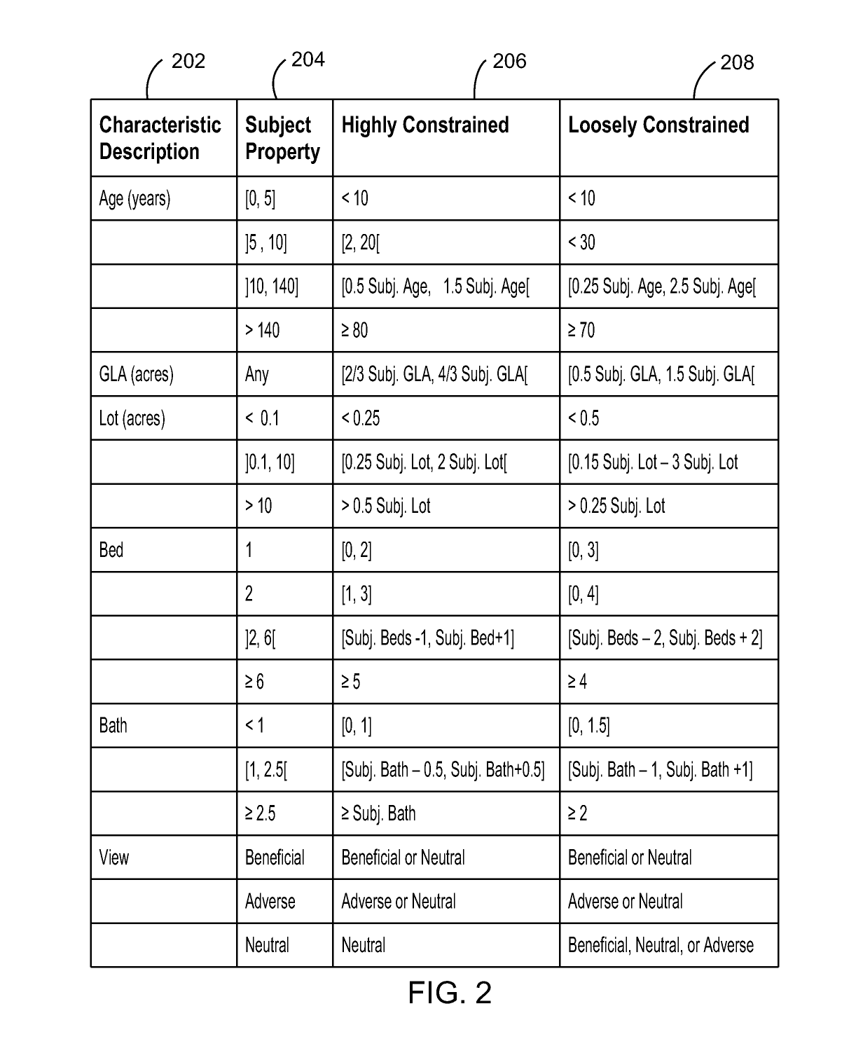

FIG. 2 is a tabular diagram illustrating an example of property characteristic filtering information. Specifically, an identification of the property characteristic 202, subject property information ranges 204 and corresponding highly constrained 206 and loosely constrained 208 filter settings are provided. Note that the figure shows only one intermediate step between highly constrained to completely relaxed, however, the algorithm can handle any number of progressively looser sets of filters.

The initial pass of identifying comparable properties uses the highly constrained settings 206, and then (e.g., after the geographic filter is relaxed) individual components of the property characteristic filter settings are relaxed to loosely constrained 208 level, preferably in an iterative fashion (i.e., not all at once) as explained above.

Thus, in the “age” characteristic, a 10 year old subject property would have a highly constrained 206 filter that would produce a range of 0.5 through 1.5 times the subject property's age. (Note, the syntax 110 denotes 10 or more). The loosely constrained 208 filtering for comparables to the same subject property would be a range of 0.25 through 2.5 times the subject property's age.

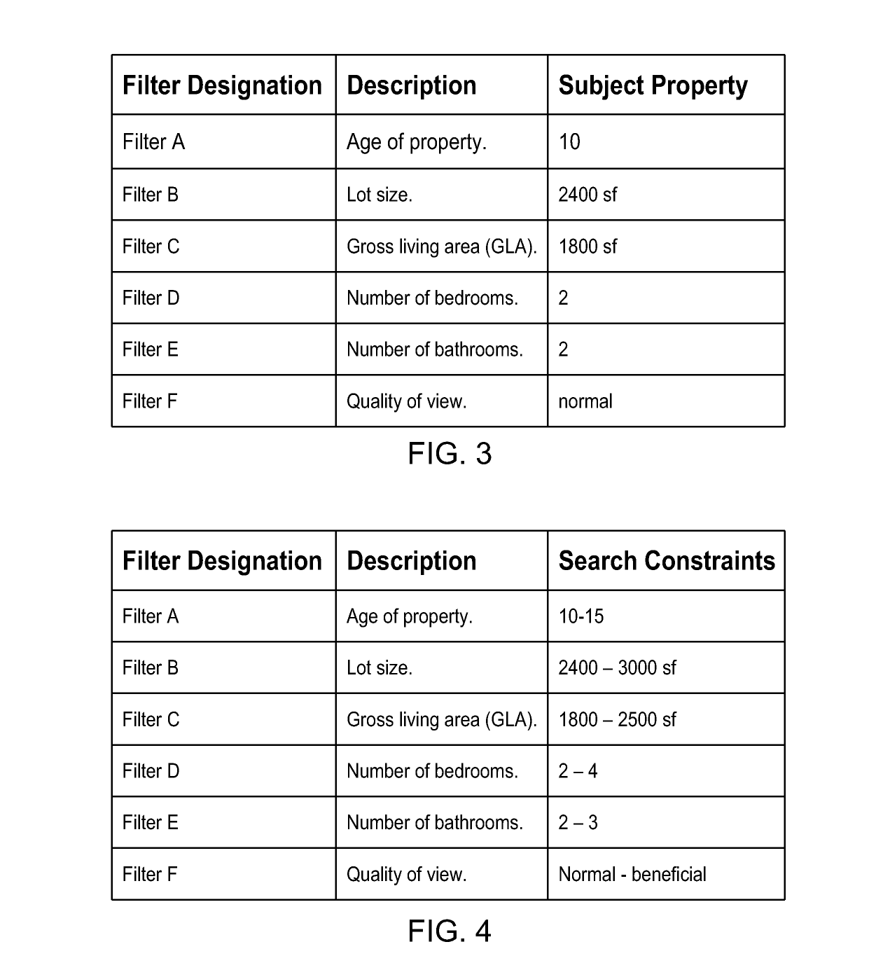

An example of subject property information and corresponding highly constrained filter settings is shown in FIGS. 3-4. Specifically, FIG. 3 is a tabular diagram illustrating the filter designations 302, corresponding description 304 and values for an example of a subject property 306. FIG. 4 is a tabular diagram illustrating the filter designations A-F 402, corresponding description 404, and what the highly constrained filter settings for comparables would be given the initial settings depicted in FIG. 2. Thus, for example, the highly constrained filter settings for a 10 year old subject property would allow comparable properties having an age of 10-15 as accepted comparables.

In a given process, there will typically be an initial step (the most stringent) and a final step (fully relaxed), with intermediate gating there between. The number of intermediate steps can be indefinite. For simplicity, one intermediate step is illustrated, thus three total steps, but the dynamic gating process can accommodate any number of intermediate steps without appreciable loss in computing time since, as noted, the comps are tagged in one loop.

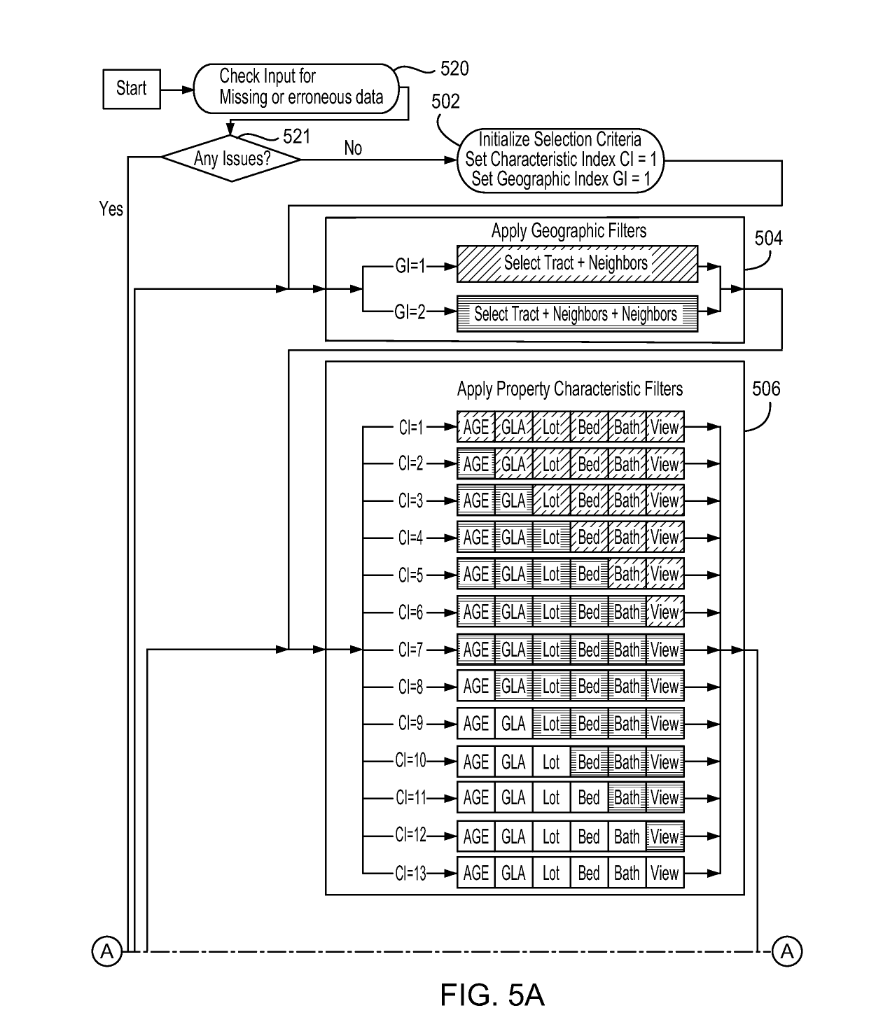

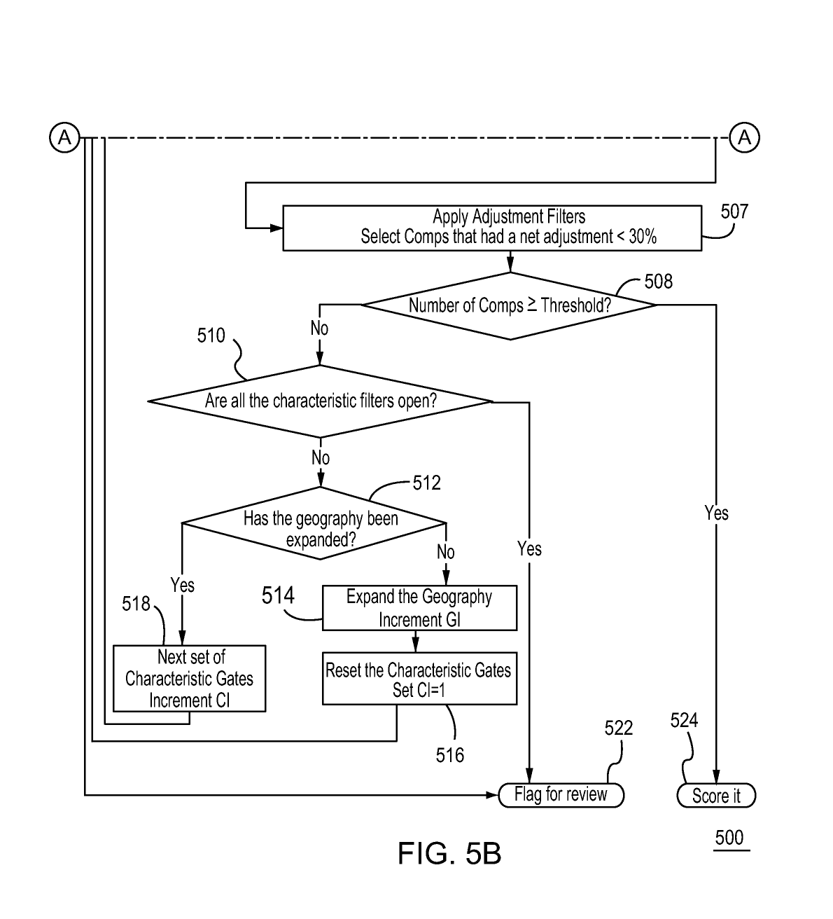

FIGS. 5A-B are flow diagrams illustrating the dynamic gating process 502 in more detail. Initially, as with the previously described process, the input is checked 520 for missing or erroneous data, and if any issues are detected 521, then the situation is flagged 522 for review.

Also, the initialization of settings 502, application of geographic filtering 504, application of property characteristic and adjustment filters (506, 507), and comparison of resultant number of comparable properties to a threshold to determine 508 whether sufficient comparables exist to score 524 or flag for review 522 (upon opening of all the gates and insufficient number of comparables) are similar to the corresponding portions of FIG. 1, and need not be re-described in detail.

However, the dynamic gating process 500 as set forth in the figure offers additional detail regarding examples of geographic and characteristic settings. The initial setting (GI=1) for the geographic area filtering (504) is set to “Tract+Neighbors” and the expanded (relaxed) setting (GI=2) is set to “Tract+Neighbors+Neighbors”). Note “neighbors” refers to any tracts that physically touch the subject's tract. Also, although “tract” is used as one example of the selection geography, any geographical selection region (CBG, school zone, etc.) can be used instead.

Also indicated is an example sequence of property characteristic filtering 506, with potentially 13 different relaxed settings (CI=1 through CI=13) being applied for respective iterations of the dynamic gating process. As evident from the figure, each of AGE, GLA, LOT, BED, BATH and VIEW characteristics are constrained to the highest level on the initial settings, then then AGE characteristic is filtered to an intermediate level on the second pass (CI=2), then other characteristics are relaxed on iterative passes until all of the characteristics are filtered to an intermediate level (at CI=7), then the filters are progressively set to the lowest level (or least restrictive, starting at CI=8) and ultimately all of the characteristics are subject to the lowest level of filtering (at CI=13).

This is merely an example of a sequence, as noted above, the iterations and level of filtering may be customized as desired through default and/or user configuration.

Also similarly to FIG. 1, on an initial pass without sufficient comparables, the property characteristic filters are determined 510 not to be open, and the geography is not yet expanded (512), so it is expanded 514 and the property characteristic gates/filters are set to the initial settings 516. If this continues to result in an insufficient number of comparables (comparison to threshold 508), then subsequent passes will indicate the geographic settings as having been expanded (512) so that the next set of characteristic gates/filters is used by incrementing CI to the next level (518). The process continues until a resultant number of comparable properties meets or exceeds the threshold, or until all gates/filters are open and insufficient number of comparables are not found (e.g., flag for review).

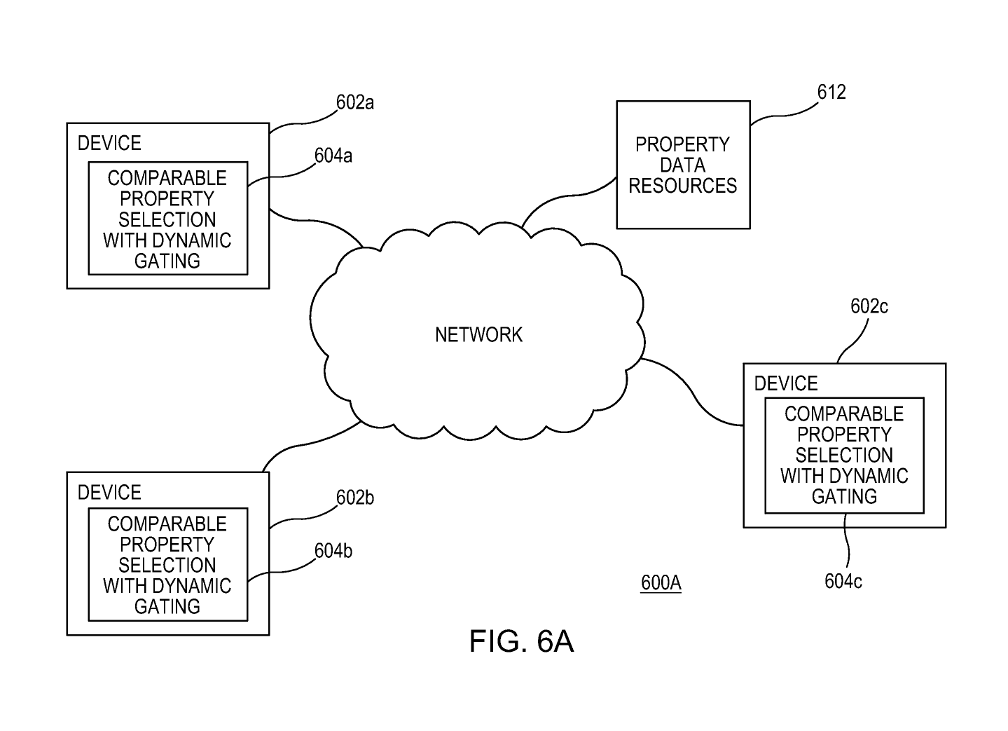

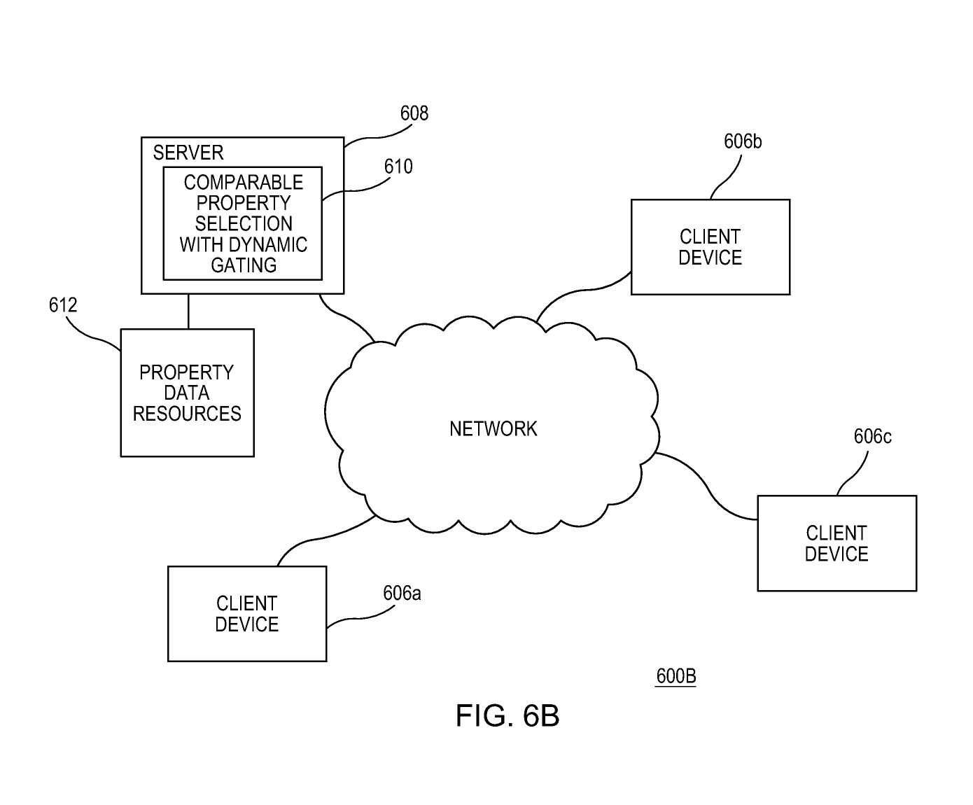

FIGS. 6A-B are block diagrams illustrating examples of systems 600A-B in which comparable property selection with dynamic gating operates.

FIG. 6A illustrates several user devices 602a-c each having a comparable property selection with dynamic gating application 604a-c.

The user devices 602a-d are preferably computer devices, which may be referred to as workstations, although they may be any conventional computing device. The network over which the devices 602a-d may communicate may also implement any conventional technology, including but not limited to cellular, WiFi, WLAN, LAN, or combinations thereof.

In one embodiment, the comparable property selection with dynamic gating application 604a-c is an application that is installed on the user device 602a-c. For example, the user device 602a-c may be configured with a web browser application, with the application configured to run in the context of the functionality of the browser application. This configuration may also implement a network architecture wherein the comparable property mapping applications 604a-c provide, share and rely upon the comparable property mapping application 604a-c functionality.

As an alternative, as illustrated in FIG. 6B, the computing devices 606a-c may respectively access a server 608, such as through conventional web browsing, with the server 608 providing the comparable property selection with dynamic gating application 610 for access by the client computing devices 606a-c. As another alternative, the functionality may be divided between the computing devices and server. Finally, of course, a single computing device may be independent configured to include the comparable property mapping application.

As illustrated in FIGS. 6A-B, property data resources 610 are typically accessed externally for use by the comparable property selection with dynamic gating application, since the amount of property data is rather voluminous, and since the application is configured to allow access to any county or local area in a very large geographical area (e.g., for an entire country such as the United States). Additionally, the property data resources 610 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property selection with dynamic gating application accesses and retrieves the property data from these resources in support of the modeling of comparable properties as well as the rendering of map images of subject properties and corresponding comparable properties, and the display of supportive data (e.g., in grid form) in association with the map images. It also performs the dynamic gating process, including determining initial filter settings respectively corresponding to location and property characteristics, the initial filter settings being configured to identify properties that most closely match the subject property based upon proximity to the location of the subject property and similarity to the property characteristics of the subject property; identifying an initial number of suitable comparable properties based upon the initial filter settings; determining whether the initial number of suitable comparable properties is below a predetermined threshold; and iteratively relaxing individual settings among the initial filter settings until an updated number of suitable comparable properties meeting the relaxed settings reaches the predetermined threshold.

Although any AVM may be used in conjunction with the above described comparable property selection with dynamic gating, one example of a hedonic equation usable in an AVM is described below. The AVM may be used to provide valuation information with respect to property characteristics. This is useful, for example, in determining the net value of adjustments to be made to a comparable as compared to the subject property. Additionally, the AVM may be used to place the ultimate valuation on the corresponding properties and for producing other output such as a quantified economic distance between the subject property and the comparable property, as well as an ability to rank and display results.

In the example of the hedonic equation offered herein, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Continuous property characteristics:

(a) log of gross living area (GLA),

(b) log of Lot Size,

(c) log of Age, and

(d) Number of Bathrooms;

(e) Number of Bedrooms; and

(f) View (categorical: beneficial, adverse, neutral)

(2) Fixed effect variables:

(a) location fixed effect (e.g., by Census Block Group (CBG));

(b) Time fixed effect (e.g., measured by 3-month periods (quarters) counting back from the estimation date); and

(c) Foreclosure status fixed effect, which captures the maintenance condition and possible REO discount.

The above is offered as an example, and as noted, there may be departures. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

Given the pool of comps selected by the model, the sale price of each comp may then be adjusted to reflect the difference between a given comp and the subject in each of the characteristics used in the hedonic price equation.

The results of the regression may be used to monetize the value of the adjustments. For example, the coefficients may be used to calculate whether the net adjustments to a comparable vis-à-vis the subject property exceed a threshold such as 30%.

An economic distance D_{eco} between the subject property and a given comp may also be determined, which may be used to offer an evaluation of the comparable that may be used separately from the dynamic gating process (e.g., for post-processing evaluation of results, or perhaps ranking of results alongside the results produced by an appraisal report).

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , bed , view , loc , time , fcl \}} ( {A}_{i} - 1 )} \qquad ( Eq . 1 )$$

If post processing comparison is desired, the comps may be weighted accordingly. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} \qquad ( Eq . 2 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi\end{matrix} , \qquad ( Eq . 3 )$$

and dT is a down-weighting age of comp sale factor

$${dT}_{SC} = \{ \begin{matrix}1.00 & if ( 0 , 90 ] days \\ 1.25 & if ( 90 , 180 ] days \\ 2.00 & if ( 180 , 270 ] days \\ 2.50 & if ( 270 , 365 ] days\end{matrix} . \qquad ( Eq . 4 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 5 )$$

The separate weighting following the determination of the adjustment factors can be used for post-processing activities such as evaluating comparables after the dynamic gating process has taken place. Also, policy factors such as those for age of sale data or location may be separately instituted in the weighting process. Although one example is illustrated it should be understood that the artisan will be free to design the weighting and other factors as necessary.

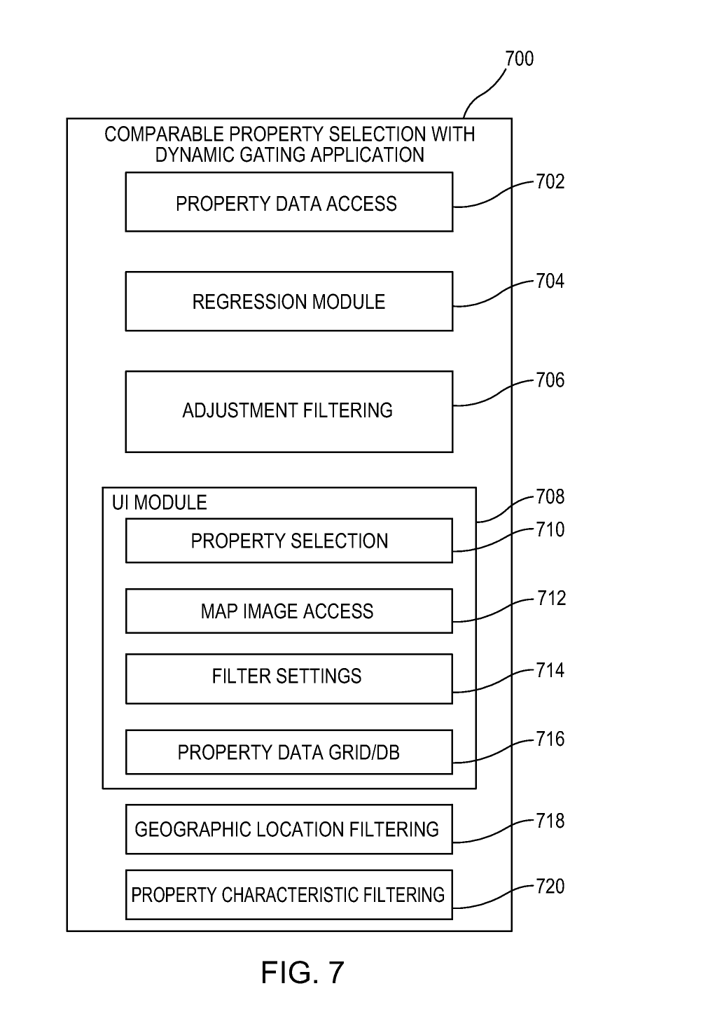

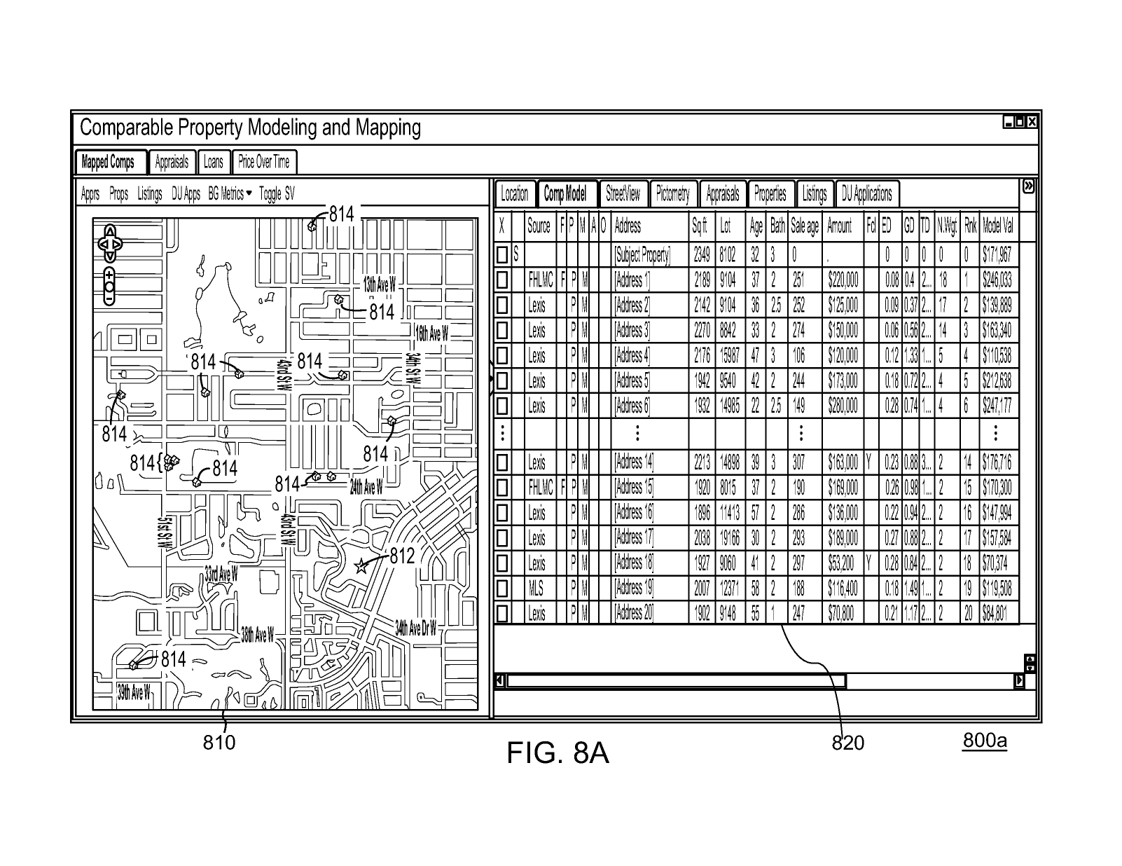

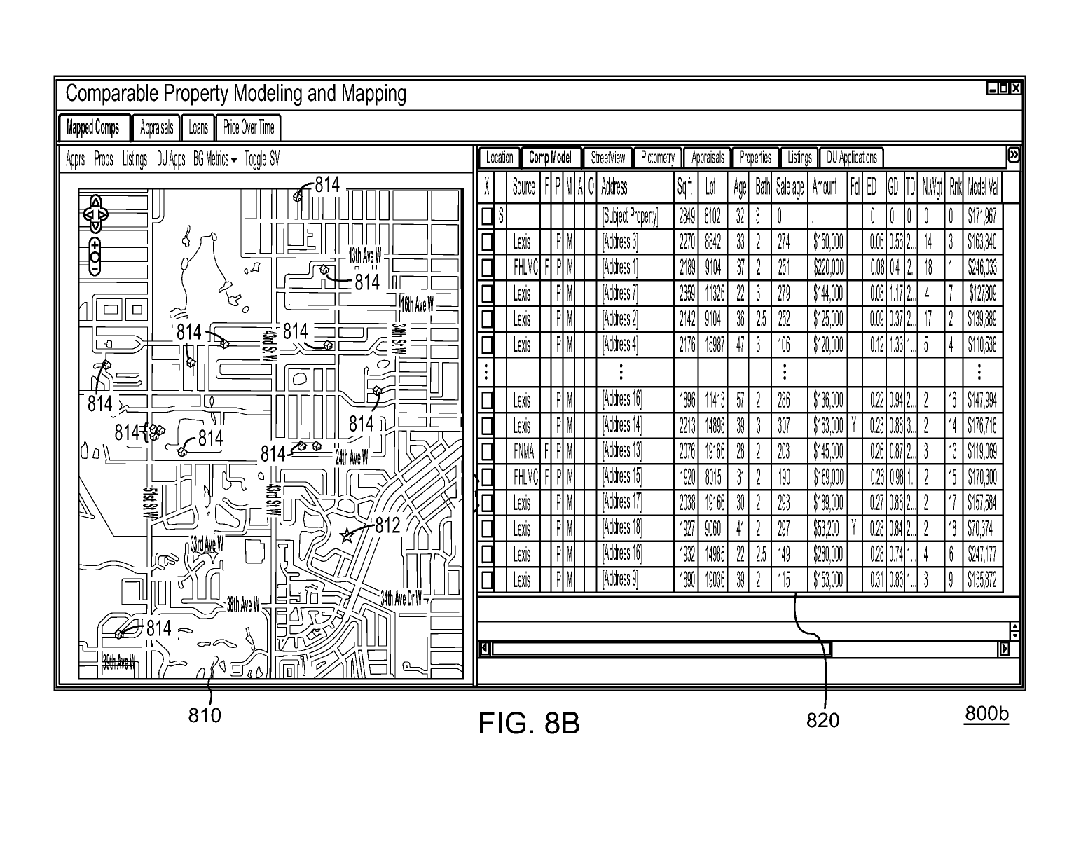

FIG. 7 is a block diagram illustrating an example of a comparable property selection with dynamic gating application 700. The application 700 preferably comprises program code that is stored on a computer readable medium (e.g., compact disk, hard disk, etc.) and that is executable by a processor to perform operations in support of modeling and mapping comparable properties.

According to one aspect, the application 700 includes program code executable to perform operations for automatically identifying comparable properties. This may include accessing property data corresponding to a geographical area; identifying a subject property having a location and property characteristics; determining initial filter settings respectively corresponding to location and property characteristics, the initial filter settings being configured to identify properties that most closely match the subject property based upon proximity to the location of the subject property and similarity to the property characteristics of the subject property; identifying an initial number of suitable comparable properties based upon the initial filter settings; determining whether the initial number of suitable comparable properties is below a predetermined threshold; and iteratively relaxing individual settings among the initial filter settings until an updated number of suitable comparable properties meeting the relaxed settings reaches the predetermined threshold.

The application 700 also includes program code executable for applying adjustment filters configured to exclude properties from the updated number of suitable comparable properties where a set of adjustments for a given property exceeds an adjustment threshold.

The application also includes program code executable for relaxing a geographic setting to expand an area for identifying the suitable comparable properties, and if applicable determining that relaxing the geographic setting does not result in the revised number of suitable comparable properties reaching the predetermined threshold, and then iteratively relaxing the initial filter settings for each of a plurality of the property characteristics until the revised number of suitable comparable properties reaches the predetermined threshold.

The application 700 is also configured to access property data corresponding to a geographical area, and performing a regression based upon the property data, with the regression modeling the relationship between price and explanatory variables. It is also configured to calculate adjustments and determine economic distance and weighting information to rank comparables, and to score appraisal reports by comparing the results in the appraisal reports to those automatically generated by the comparable property selection functionality.

The application 700 also includes program code for displaying a map image corresponding to the geographical area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The comparable property selection with dynamic gating application 700 is preferably provided as software, but may alternatively be provided as hardware or firmware, or any combination of software, hardware and/or firmware. The application 700 is configured to provide the comparable property modeling and mapping functionality described herein. Although one modular breakdown of the application 700 is offered, it should be understood that the same functionality may be provided using fewer, greater or differently named modules.

The example of the comparable property selection application 700 of FIG. 7 includes a property data access module 702, regression module 704, adjustment filtering module 706, and UI module 708, with the UI module 708 further including a property selection module 710, map image access module 712, filter settings module 714 and property data grid/DB module 716.

The property data access module 702 includes program code for carrying access and management of the property data, whether from internal or external resources. The regression module 404 includes program code for carrying out the regression upon the accessed property data, according to the regression algorithm described above, and produces corresponding results such as the determination of regression coefficients and other data at the country (or other) level as appropriate for a subject property. The regression module 704 may implement any conventional code for carrying out the regression given the described explanatory variables and property data.

The adjustment filtering module 706 is configured to apply the adjustment filtering as described. For example, the adjustment filtering module 706 determines a net value of adjustments corresponding to any given comparable as compared to a subject property. This may be performed using the coefficients produced by the AVM/regression module. Filtering is applied according to the settings, either default settings or those input by the user through the filter settings module 714. The geographic location filtering 718 and property characteristics filtering 720 modules respectively access the corresponding filtering settings, and apply the appropriate filtering conditions as the dynamic gating algorithm progresses through its iterations. Again, the filtering settings may be according to default or user-configured settings as stored in the filter settings module 714.

The UI module 708 manages the display and receipt of information to provide the described functionality. It includes a property selection module 710, to manage the interfaces and input used to identify one or more subject properties, from which a determination of the corresponding geographical area is determined in support of defining the scope of the regression and other functionality. The map image access module 712 accesses mapping functions and manages the depiction of the map images as well as the indicators of the subject property and the comparable properties. The property data grid/DB 716 manages the data set corresponding to a current session, including the subject property and pool of comparable properties. It is configured as a database that allows the property data for the properties to be displayed in a tabular or grid format, with various sorting according to the property characteristics, economic distance, geographical distance, time, etc.

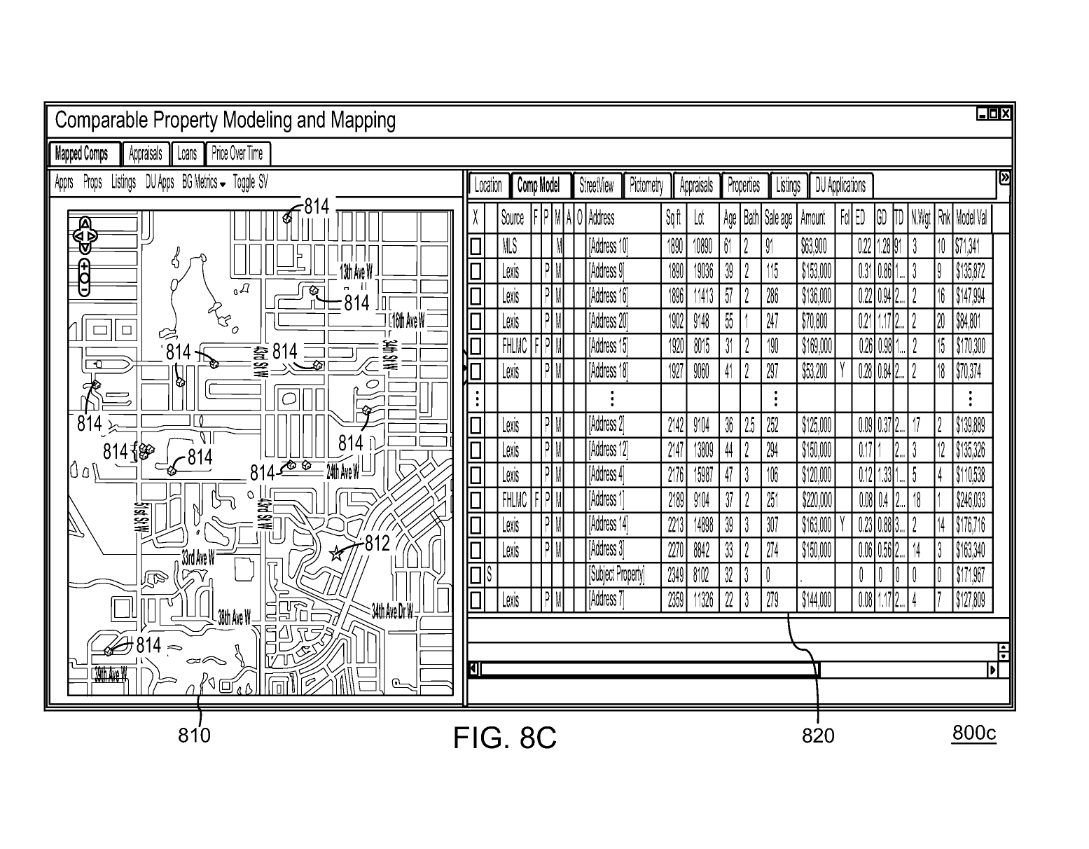

FIGS. 8A-C are display diagrams illustrating examples of map images and corresponding property grid data generated by the comparable property application.

For example, FIG. 8A illustrates an example of a display screen 800a that concurrently displays a map image 810 and a corresponding property data grid 820. This screen may be displayed following selection of a subject property by a user followed by prompting a running of the comparable property model, which identifies the comparable properties, determines adjustment factors, determines economic distance and weights the comparable properties, such as described above.

The map image 810 depicts a region that can be manipulated to show a larger or smaller area, or moved to shift the center of the map image, in convention fashion. This allows the user to review the location of the subject property 812 and corresponding comps 814 at any desired level of granularity. This map image 810 may be separately viewed on a full screen, or may be illustrated alongside the property data grid 820 as shown.

The property grid data 820 contains a listing of details about the subject property and the comparable properties, as well as various information fields. The fields include an identifier field (e.g., “S” indicates the subject property), the source of data for the property (“Source”), the address of the property (“Address”), the square footage (“Sq Ft”), the lot size (“Lot”), the age of the property (“Age”), the number of bathrooms (“Bath”), the age of the prior sale (“Sale Age”), the prior sale amount (“Amount”), the foreclosure status (“FCL”, y/n), the economic distance (“ED”), geographic distance (“GD”) and time distance (“TD”, e.g., as measured in days) factors as described above, the weight (“N. Wgt”), the ranking by weight (“Rnk”), and the valuation as determined from the comparable sales model (“Model Val”).

The map image 810 allows the user to place a cursor over any of the illustrated properties to prompt highlighting of information for that property and other information. Additionally, the listing of comparables in the property grid data 820 can be updated according to any of the listed columns. For example, the display screen 800b in FIG. 8B illustrates the listing sorted by the economic distance, and the display screen 800c in FIG. 8C illustrates sorting according to the square footage of the properties. The grid data can be variously sorted to allow the user to review how the subject property compares to the listed comparable properties.

The user may variously update the map image and manipulate the property data grid in order to review and assess and subject property and the corresponding comparable properties in a fashion that is both flexible and comprehensive.

Thus embodiments of the present invention produce and provide methods and apparatus for dynamic gating for automated selection of comparable properties. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for automatically identifying comparable properties, the method comprising:
accessing property data corresponding to a geographical area;
identifying a subject property having a location and property characteristics;
determining initial filter settings respectively corresponding to location and property characteristics, the initial filter settings being configured to identify properties that most closely match the subject property based upon proximity to the location of the subject property and similarity to the property characteristics of the subject property;
identifying an initial number of suitable comparable properties based upon the initial filter settings;
determining whether the initial number of suitable comparable properties is below a predetermined threshold; and
iteratively relaxing individual settings among the initial filter settings until an updated number of suitable comparable properties meeting the relaxed settings reaches the predetermined threshold.

2. The method of claim 1, further comprising:
applying adjustment filters configured to exclude properties from the updated number of suitable comparable properties where a set of adjustments for a given property exceeds an adjustment threshold.

3. The method of claim 1, wherein iteratively relaxing the individual settings comprises initially relaxing a geographic setting to expand an area for identifying the suitable comparable properties.

4. The method of claim 3, further comprising:
determining that relaxing the geographic setting does not result in the revised number of suitable comparable properties reaching the predetermined threshold; and then
iteratively relaxing the initial filter settings for each of a plurality of the property characteristics until the revised number of suitable comparable properties reaches the predetermined threshold.

5. The method of claim 4, wherein an initial geographic setting is set as tract plus neighboring tracts corresponding to the subject property.

6. The method of claim 5, wherein the plurality of the property characteristics comprises age, gross living area, lot size, number of bedrooms and number of bathrooms.

7. The method of claim 1, further comprising:
once the updated number of suitable comparable properties reaches the predetermined threshold, weighting the suitable comparable properties based upon the appropriateness of each of the plurality of comparable properties as comparables for the subject property, the weighting being based upon one or more of the economic distance from the subject property, geographic distance from the subject property, and age of transaction.

8. The method of claim 7, further comprising:
displaying a map image corresponding to the geographical area; and
ranking the plurality of comparable properties based upon the weighting of the suitable comparable properties; and
displaying indicators on the map image indicative of the subject property and a subset of the plurality of comparable properties, the subset being determined according to the ranking.

9. The method of claim 1, further comprising:
once the updated number of suitable comparable properties reaches the predetermined threshold, scoring the suitable comparable properties.

10. A non-transitory computer readable medium storing program code for automatically identifying comparable properties, the program code being executable by a processor to perform operations comprising:
accessing property data corresponding to a geographical area;
identifying a subject property having a location and property characteristics;
determining initial filter settings respectively corresponding to location and property characteristics, the initial filter settings being configured to identify properties that most closely match the subject property based upon proximity to the location of the subject property and similarity to the property characteristics of the subject property;
identifying an initial number of suitable comparable properties based upon the initial filter settings;
determining whether the initial number of suitable comparable properties is below a predetermined threshold; and
iteratively relaxing individual settings among the initial filter settings until an updated number of suitable comparable properties meeting the relaxed settings reaches the predetermined threshold.

11. The computer readable medium of claim 10, wherein the operations further comprise:
applying adjustment filters configured to exclude properties from the updated number of suitable comparable properties where a set of adjustments for a given property exceeds an adjustment threshold.

12. The computer readable medium of claim 10, wherein iteratively relaxing the individual settings comprises initially relaxing a geographic setting to expand an area for identifying the suitable comparable properties.

13. The computer readable medium of claim 12, wherein the operations further comprise:
determining that relaxing the geographic setting does not result in the revised number of suitable comparable properties reaching the predetermined threshold; and then
iteratively relaxing the initial filter settings for each of a plurality of the property characteristics until the revised number of suitable comparable properties reaches the predetermined threshold.

14. The computer readable medium of claim 13, wherein an initial geographic setting is set as tract plus neighbors corresponding to the subject property.

15. The computer readable medium of claim 14, wherein the plurality of the property characteristics comprises age, gross living area, lot size, number of bedrooms and number of bathrooms.

16. The computer readable medium of claim 10, wherein the operations further comprise:
once the updated number of suitable comparable properties reaches the predetermined threshold, weighting the suitable comparable properties based upon the appropriateness of each of the plurality of comparable properties as comparables for the subject property, the weighting being based upon one or more of the economic distance from the subject property, geographic distance from the subject property, and age of transaction.

17. The computer readable medium of claim 16, wherein the operations further comprise:
displaying a map image corresponding to the geographical area; and
ranking the plurality of comparable properties based upon the weighting of the suitable comparable properties; and
displaying indicators on the map image indicative of the subject property and a subset of the plurality of comparable properties, the subset being determined according to the ranking.

18. The computer readable medium of claim 10, wherein the operations further comprise:
once the updated number of suitable comparable properties reaches the predetermined threshold, scoring the suitable comparable properties.

19. An apparatus for automatically identifying comparable properties, the apparatus comprising:
a processor, and
a memory, the memory storing program code executable by the processor to perform operations comprising:
accessing property data corresponding to a geographical area;
identifying a subject property having a location and property characteristics;
determining initial filter settings respectively corresponding to location and property characteristics, the initial filter settings being configured to identify properties that most closely match the subject property based upon proximity to the location of the subject property and similarity to the property characteristics of the subject property;
identifying an initial number of suitable comparable properties based upon the initial filter settings;
determining whether the initial number of suitable comparable properties is below a predetermined threshold; and
iteratively relaxing individual settings among the initial filter settings until an updated number of suitable comparable properties meeting the relaxed settings reaches the predetermined threshold.

20. The apparatus of claim 19, wherein the operations further comprise:
applying adjustment filters configured to exclude properties from the updated number of suitable comparable properties where a set of adjustments for a given property exceeds an adjustment threshold.
